(19) United States
(12) Patent Application Publication
(10) Pub. No.: US 2014/0365310 A1
(43) Pub. Date: Dec. 11, 2014

(54) PRESENTATION OF MATERIALS BASED ON LOW LEVEL FEATURE ANALYSIS

(71) Applicant: Javier MOVELLAN, La Jolla, CA (US)

(72) Inventor: Javier MOVELLAN, La Jolla, CA (US)

(73) Assignee: MACHINE PERCEPTION TECHNOLOGIES, INC., San Diego, CA (US)

(21) Appl. No.: 13/911,037

(22) Filed: Jun. 5, 2013

(51) Int. Cl. G06Q 30/02; G06K 9/00

(52) U.S. Cl. CPC G06Q 30/0269; G06K 9/00268
USPC 705/14.66

(57) ABSTRACT

A computer system obtains an image or video of a person, such as a shopper. The image or video includes the face of the person. The system extracts low level features from the image or video. The low level features may be Gabor features. The system examines the low level features to designate stimuli that are likely to result in preferred behaviors associated with the person. The system analyzes the plurality of designated stimuli based on predetermined criteria to select one or more selected stimuli, and then causes the selected stimuli to be rendered to the person. The predetermined criteria may be economic criteria, such as a requirement to select the stimulus with the highest expected economic benefit from among the various designated stimuli.

### FIELD OF THE INVENTION

This document relates generally to apparatus, methods, and articles of manufacture for making predictions/estimations of behavioral outcomes based on analysis of low level features, and selecting marketing materials for presentation based on the predictions/estimations. Selected embodiments relate to extracting small level features from a normalized image of a person's face, and selecting marketing materials based on the comparison of the extracted features to previously obtained feature-outcome correlation data.

### BACKGROUND

The usage of the Internet, personal computers, and image/video monitoring and recording devices facilitates collection of viewable information. Such information may provide clues to responses of a particular customer, a selected plurality of customers, or the general public at various events or venues.

A need exists for improved methods for analyzing the effectiveness of marketing strategies based on appearance and affective information of customers, gathered from image and video recordings of the customers. A need also exists for selecting or adjusting marketing presentations or other stimuli in response to a customer's reaction to previous stimuli.

### SUMMARY

Embodiments described in this document are directed to methods, apparatus, and articles of manufacture that may satisfy one or more of the above described and other needs.

In an embodiment, a computer-implemented method includes obtaining at least one image of a person, the at least one image having at least part of a face of the person; extracting low level features from the at least one image, thereby obtaining extracted low level features; examining the extracted low level features to designate one or more designated stimuli likely to result in one or more preferred behaviors associated with the person; and rendering at least one stimulus from among the one or more designated stimuli. Some examples of low level features are Gabor Orientation Energy, Gabor Scale Energy, Gabor phase.

In aspects, the one or more designated stimuli comprise a plurality of designated stimuli, the method further includes analyzing the plurality of designated stimuli based on one or more predetermined criteria to select the at least one selected stimulus, and the step of rendering
comprises rendering the at least one selected stimulus.

In an embodiment, a computer based system includes a processor, a memory storing machine readable instructions, a display, and a camera. The system is configured to obtain through the camera at least one image of a person, the at least one image comprising at least part of a face of the person; extract low level features from the at least one image, thereby obtaining extracted low level features; examine the extracted low level features to designate one or more designated stimuli likely to result in one or more preferred behaviors associated with the person; and render on the display at least one stimulus from among the one or more designated stimuli.

In aspects, the one or more designated stimuli comprise a plurality of designated stimuli; and the system is further configured to analyze the plurality of designated stimuli based on one or more predetermined criteria to select the at least one stimulus from among the plurality of designated stimuli.

In an embodiment, an article of manufacture has one or more memory devices storing computer code. When the code is executed by at least one computer based system, it configures the at least one computer based system to obtain at least one image of a person, the at least one image having at least part of a face of the person; extracting low level features from the at least one image, thereby obtaining extracted low level features; examining the extracted low level features to designate one or more designated stimuli likely to result in one or more preferred behaviors associated with the person; and rendering at least one stimulus from among the one or more designated stimuli.

In aspects, the one or more designated stimuli of the method include a plurality of designated stimuli; the method further includes analyzing the plurality of designated stimuli based on one or more predetermined criteria to select the at least one selected stimulus; and the step of rendering includes rendering the at least one selected stimulus.

These and other features and aspects of the present invention will be better understood with reference to the following description, drawings, and appended claims.

### BRIEF DESCRIPTION OF THE FIGURES

FIG. 1 illustrates selected steps of a process for presenting one or more marketing stimuli to a customer based on an analysis of low level features of the customer's image;

FIG. 2 illustrates selected steps of a process for extracting low level features from the customer's image; and

FIG. 3 is a block diagram representation of selected elements of a computer-based system configured to perform selected steps of methods described in this document.

### DETAILED DESCRIPTION

In this document, the words “embodiment,” “variant,” “example,” and similar expressions refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar expressions and phrases are used to indicate one of a number of different possible embodiments. The number of possible embodiments is not necessarily limited to two or any other quantity. Characterization of an item as “exemplary” means that the item is used as an example. Such characterization of an embodiment does not necessarily mean that the embodiment is a preferred embodiment; the embodiment may but need not be a currently preferred embodiment. All embodiments are described for illustration purposes and are not necessarily strictly limiting.

The words “couple,” “connect,” and similar expressions with their inflectional morphemes do not necessarily import an immediate or direct connection, but include within their meaning connections through mediate elements.

“Affective” information associated with an image or video includes various types of psychological reactions, such as affective, cognitive, physiological, and/or behavioral responses, including both recorded raw signals and their interpretations. Relevant information that represents or describes a particular customer's reaction(s) toward a stimulus in terms of the customer's affective, cognitive, physiological, or behavioral responses is referred to in the present invention as affective information. The affective information can be attributable to psychological and physiological reactions such as memories, associations, and the like.

“Stimulus” and its plural form “stimuli” refer to actions, agents, or conditions that elicit or accelerate a physiological or psychological activity or response, such as an emotional response. Stimuli include still and moving images, items and objects (described in more detail in the immediately following paragraph), smells, tastes, sounds (including without limitation music and songs), experiences, products, concepts and the like. In embodiments described throughout this document, stimuli may include at least one of an electronically displayed image, text, logo, photograph, picture, classified ad, graphic information, static image, dynamic image, streaming ad, interactive, audio, video, banner, rich media banner, placement ad, search advertising, contextual advertising, commercial message, interactive ad, interstitial ad, floating ad, wallpaper ad, pop-up, pop-under, or map ad. An image may be a still image or a moving image, or multimedia clips or fragments that include visual information. Images may be displays of pictures or similar likenesses of an object or the actual object. People create images for a variety of purposes and applications. Capturing memorable events is one example of an activity that ordinary people, professional photographers, or journalists alike have in common. These events may be meaningful or emotionally important to an individual or a group of individuals. Images of certain events attract special attention, elicit memories, feelings/emotions, or specific behaviors. One can say that these pictures of special events and moments evoke certain mental or behavioral reactions or, in general terms, psychological reactions.

The items and objects referred to in this document may include, but are not limited to, consumables, comestibles, clothing, shoes, toys, cleaning products, household items, machines, any type of manufactured items, entertainment and/or educational materials, as well as entrance or admittance to attend or receive an entertainment or educational activity or event, as well as the packaging, branding, messaging or marketing of such items. Items for purchase could also include services, such as, without limitation, dry cleaning services, food delivery services, automobile repair services, vehicle detailing services, personal grooming services, such as manicures and haircuts, cooking demonstrations, and any other services.

“Causing to be displayed” and analogous expressions refer to taking one or more actions that result in displaying. For example, a server computer may cause a Web page to be displayed by making the web page available for access by a client computer over a network, such as the Internet, which web page the client computer can then display to a user.

“Rendering” and its inflectional morphemes refer to producing/delivering/presenting a stimulus that can be sensed by a customer, including causing to be displayed an image and/or video, generating a sound, generating a smell, and similar concepts.

Other and further explicit and implicit definitions and clarifications of definitions may be found throughout this document.

Reference will be made in detail to several embodiments that are illustrated in the accompanying drawings. Same reference numerals are used in the drawings and the description to refer to the same apparatus elements and method steps. The drawings are in a simplified form, not to scale, and omit apparatus elements and method steps that can be added to the described systems and methods, while possibly including certain optional elements and steps.

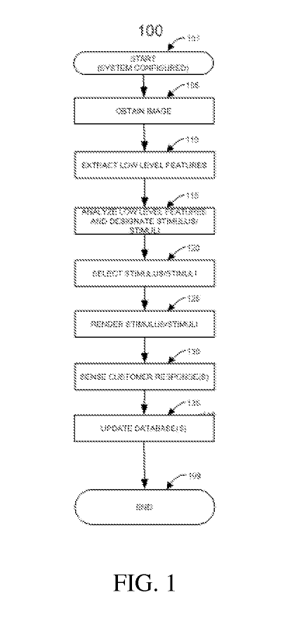

FIG. 1 illustrates selected steps of an operational flow of a process 100 for presenting one or more marketing stimuli to one or more customers. The stimuli may be or may include, for example, electronically displayed image(s) and/or video(s). Although the process steps and decisions (if decision blocks are present) are described serially, certain steps and/or decisions may be performed by separate elements in conjunction or in parallel, asynchronously or synchronously, in a pipelined manner, or otherwise. There is no particular requirement that the steps and decisions be performed in the same order in which this description lists them or this Figure and/or other Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific variants use the particular order(s) in which the steps are shown and/or described.

In the process 100, at least one image of a customer is acquired, low level features are extracted from the image, the low level features are analyzed and compared to a database containing low level features and their associations with customer behaviors and/or outcomes, and at least one appropriate stimulus is selected for rendering to the customer based on the results of the analyzing/comparing steps; the selected stimulus is then delivered to the customer.

In more detail and with reference to FIG. 1, at flow point 101 a system for performing the process 100 is properly configured and ready to perform the steps of the process.

In step 105, the system obtains at least one image (which may include a video) of a customer. For example, the customer's facial image may be taken by a camera when the customer is in a store. The image may be black-and-white or in color. Even if the image is a color image, it may subsequently be converted into a black-and-white image.

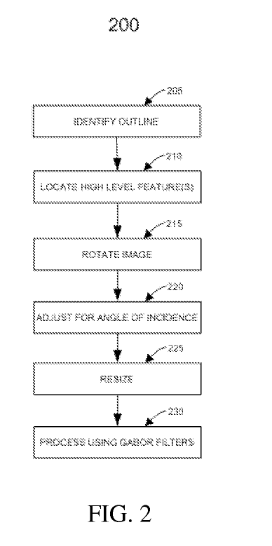

In step 110, the image is processed to extract low level features. The features are “low level” in the sense that they are not attributes used in everyday life language to describe facial information, such as eyes, chin, cheeks, brows, forehead, hair, nose, ears, gender, age, ethnicity, etc. In embodiments, the extracted low level features may be filter responses of Gabor filters, as will be discussed below with reference to FIG. 2. Examples of low level features are Gabor orientation energy, Gabor scale energy, Gabor phase, Haar wavelet outputs.

In step 115, the extracted low level features are examined using, for example, one or more databases that store various low level features and their associations with customers' behaviors and/or behavioral outcomes. For example, the extracted low level features may be compared to the features stored in a database, to designate one or more stimuli that are likely (i.e., more likely relative to other available stimuli) to result in preferred behaviors or behavioral outcomes, and the corresponding probabilities of the preferred behaviors or outcomes based on the extracted features. The information in the database(s) may be obtained through previous and/or continuing statistical correlation of outcomes with extracted low level features. In other words, the information in the database(s) may be a product of previous and/or continuing training of the system.

In step 120, the designated stimuli and their corresponding probabilities are analyzed to select a subset of the stimuli based on one or more predetermined criteria. For example, a single stimulus with the highest expected economic return may be selected. As another example, a plurality of N (two or more) stimuli may be selected so that the expected economic return is the highest possible for a subset of N stimuli from among all the designated stimuli. Note that the selected stimuli may be directed to different sensory organs, for example, a combination of a marketing jingle and an advertising image, or a combination of an advertising image and a scent. Also, the selected stimuli may be promoting a single product or company, or a plurality of products and/or companies; for example, two advertising images for two different (either related or unrelated) companies/products may be displayed. Economic criterion or criteria (such as the expected economic return) may be combined with or supplanted by one or more other criteria. The other criteria may include fairness (e.g., each stimulus of a plurality of stimuli gets to be selected over time, even when it is not necessarily the highest expected economic return stimulus), legal requirements (e.g., anti-smoking messages are selected every so often), database training considerations (e.g., updating the probabilities in the database based on more current data, or determining probabilities for new stimuli such as new marketing messages), and still further criteria. The other criteria may be used to the exclusion of the economic criteria.

In step 125, the selected one or more stimuli are rendered or delivered to the customer (made available to the customer). For example, a still image is displayed, a video clip is played, and/or an aroma or a scent is emitted.

In step 130, the customer's reaction and/or the associated behavior or outcome responsive to the rendering of the one or more stimuli is (or are) sensed. Here, a reaction may be a change in the customer's facial expression, for example, a smile or another display of pleasure (which may be sensed using high level feature analysis). The actual outcome may be caused directly by another person; for example, when the customer is a child, the outcome (say, a purchase) may be made by a parent.

In step 135, the database is updated based on the sensed behavior or outcome. For example, a purchase of a product in response to a particular stimulus may result in an increased probability of the product's purchase being associated with the particular stimulus.

The process can then end at flow point 199. The steps or a subset of the steps may be repeated again and again, as desired.

In variants, the database is updated following one or more iterations of the process, with future stimulus or a set of stimuli being selected based on the reaction to the immediately preceding stimulus (or stimuli), or based on the reactions to several or even all of the preceding stimuli. This is in effect dynamic training of the system.

In variants, the process may be performed substantially in real time, that is, a stimulus may be presented to a customer within seconds (e.g., less than five seconds) of the capture of the image in the step 105.

The extraction of the low level features (the step 110) may proceed as described below with reference to a process 200 illustrated in FIG. 2. This description is exemplary, so that other (sub-)steps may be used in the step 110. Although the process steps and decisions (if decision blocks are present) are described serially, certain steps and/or decisions may be performed by separate elements in conjunction or in parallel, asynchronously or synchronously, in a pipelined manner, or otherwise. There is no particular requirement that the steps and decisions be performed in the same order in which this description lists them or this Figure and/or other Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific variants use the particular order(s) in which the steps are shown and/or described.

In step 205, the image is processed to identify an outline of a face and/or of a head and related postural/anatomical features.

In step 210, one or more selected high level features in the face outline are located. For example, eyes, nose, forehead, hair, chin, and/or cheeks may be located; one or more of these high level features may be located first, and then one or more other features may be located based on the location of the feature that have previously been located. In particular variants, the eyes are located first, and the other high level features are located with reference to the locations of the eyes.

In step 215, the outline may be rotated (if needed) to a predetermined orientation in the plane of the image.

In step 220, the rotated face outline may be adjusted to a normal angle of incidence. In other words, if the image was taken from an angle other than normal with respect to the plane of the face, the rotated face outline is adjusted to correspond to a normal angle between a line from the point at which the image was taken to the approximate center of the outline in the plane of the face.

In step 225, the adjusted face outline may be resized to a predetermined size or range of sizes of a selected feature or to a predetermined size or range of sizes of the outline itself.

In some embodiments, the step 210 (locating the high level features) is performed after the step 215 (rotating the face outline); after the step 220 (adjusting to a normal angle of incidence); and/or after the step 225 (resizing). Of course, other sequences, omission of some steps, addition of some other steps, and concurrent execution of the steps are not necessarily excluded from the scope of this document.

In step 230, the resized image may be processed using a plurality of Gabor filters. The filters may number in the hundreds, thousands, millions, or even higher numbers. Each of the Gabor filters may be applied to an output of a pixel mask applied to the facial image. A particular mask may be such that only a relatively small number of pixels go through the mask, with the rest being obscured by the particular mask. The filters may be predetermined based on a training experience, and they may also be dynamically adjustable based on the ongoing performance of the system and the actual results obtained from it. The masks may leave uncovered, for example, pixels of a single contiguous shape or of several unconnected shapes.

The Gabor filters may be two-dimensional, with each filter being a product of a sinusoidal plane wave and a Gaussian kernel function; or three-dimensional, with each filter being a product of a sinusoidal image moving orthogonally to its wave front, and a spatio-temporal Gaussian kernel function. A reader interested in learning more about the use of Gabor filters in facial image processing may read a number of publication, including Wang, U.S. Patent Application Publication Number 2010/0232657 (“Wang”); and Sung, U.S. Patent Application Publication Number 2006/0104504 (“Sung”). Other types of low-level features, include, but are not limited to, Box Filters, Haar Wavelets, scale-invariant feature transform (SIFT) features, etc.

Generally, the process 100 applies machine learning to low level features of a person to make predictions of the person's reactions to various stimuli, and then selects one or more stimuli based on the predictions. Mathematically speaking, this may be a problem in Stochastic Optimal Control. The goal of the controller may be to optimize a performance function (e.g., maximize the expected value of a customer's purchase), the sensors available to the controller are the low level features (e.g., Gabor filters) provided by cameras, and the actions available to the controller include the products shown in a display, sounds, music, smells, etc. Machine learning, particularly reinforcement learning methods, may be used to find approximate solutions to this control problem. Example reinforcement learning methods include Q-Learning, TD-Lambda, and Differential Dynamic Programming. These methods can be used in combination with data mining and of pattern recognition algorithms, such as neural networks, support vector machines, and other types of classifiers. The system may use low level features, instead of or in addition to high level demographic information, to modify its actions. For example, the system may discover that it is a good idea to play a particular category of music to people who happen to have a particular configuration of Gabor fitter outputs. This particular configuration may not be easily describable with everyday language. For example, it may not correspond to standard demographic categories, such as age, gender, and race.

Facial expressions in the captured images can be processed using a facial expression recognition algorithm. Facial expressions and changes in them can be analyzed using many algorithms for facial expression recognition, such as an algorithm developed by Essa and Pentland; see I. A. Essa and A. Pentland, FACIAL EXPRESSION RECOGNITION USING A DYNAMIC MODEL AND MOTION ENERGY, Proceedings of the ICCV 95, Cambridge, Mass. (1995). The Essa and Pentland algorithm is based on the knowledge of the probability distribution of the facial muscle activation associated with each expression and a detailed physical model of the skin and muscles. The physics-based model is used to recognize facial expressions through comparison of estimated muscle activations from the video signal and typical muscle activations obtained from a video database of emotional expressions.

Facial expressions and their changes can also be analyzed by means of other algorithms, including these exemplary ones: J. J. Lien, T. Kanade, J. F. Cohn and C. C. Li, DETECTION, TRACKING, AND CLASSIFICATION OF ACTION UNITS IN FACIAL EXPRESSION, Robotics and Autonomous Systems, 31, pp. 131-146 (2000); Bartlett, M. S., Hager, J. C., Ekman, P., and Sejnowski, T. J., MEASURING FACIAL EXPRESSIONS BY COMPUTER IMAGE ANALYSIS, Psychophysiology, 36, pp. 253-63 (1999). These algorithms are based on recognizing specific facial actions—the basic muscle movements—which were described by P. Ekman and W. Friesen, FACIAL ACTION CODING SYSTEM, Consulting Psychologists Press, Inc., Palo Alto, Calif. (1978). The basic facial actions may be combined to represent any facial expressions. For example, a spontaneous smile can be represented by two basic facial actions: 1) the corners of the mouth are lifted up by a muscle called zygomaticus major; and 2) the eyes are crinkled by a muscle called orbicularis oculi. Therefore, when uplifted mouth and crinkled eyes are detected in the video signal, it may be interpreted that a person in the video is smiling. As a result of the facial expression analysis, a user's face can be recognized as smiling when a smile on the user's face is detected, or not smiling when the smile is not detected.

Facial expressions can be analyzed for affective information, and tagging of the stimulus, or a portion thereof. For example, an advertisement or a video can be presented to the user and various portions of the video can be associated with affective tags.

Affective tagging is the process of determining affective information, and storing the affective information in association with the stimulus or stimuli from which the affective information resulted. When the affective information is stored in association with a user identifier, it is referred to as “personal affective information.” When the personal affective information is stored in association with the corresponding stimulus, it is referred to as “personal affective tag.” The affective information and user identifier are types of “metadata,” which is a term used for any information relating to a stimulus. Examples of other types of metadata include capture time, capture device, capture location, date of capture, capture parameters, editing history, etc. Processing of the facial expressions may be based in part on such metadata.

Processing of the low level features and/or the facial expressions can be performed on the client side, e.g., the user's computer installed in a store; on the server side, e.g., on the remote server that acquires the facial expressions from the user's client computer, for example, through a network, such as one or more of a local area network (LAN), a wide area network (WAN), the Internet, or through Cloud based services, on both the user and server sides.

Various aspects of the present invention may be implemented using any of a wide variety of devices and computing platforms, in any of a variety of network types (or combinations thereof), and in any of a wide variety of contexts. For example, implementations are contemplated in which the user is recorded on personal computers, media computing platforms (e.g., gaming platforms, cable and satellite set top boxes with navigation and recording capabilities), handheld computing devices (e.g., PDAs, handheld gaming platforms), other portable mobile device (e.g., cell or smart phones), digital displays, vehicle-based computer systems, retail computer kiosks, electronic picture frame devices, video or still cameras, or any other type of portable communication and/or computing platform. It is also contemplated that the network may include landline and cellular connections, among other kinds of connections. Instructions for performing all or some of the steps of the methods described in this document may be resident on some of these devices, e.g., in connection with a browser, messaging, or other application, or be served up from a remote site, e.g., in a web page or a messaging application.

The analyzed image may be obtained by any type of known or available camera, including, but not limited to, a video camera for taking moving video images, a digital camera capable of taking still pictures and/or a continuous video stream, a stereo camera, a web camera, and/or any other imaging device capable of capturing a view of whatever appears within the camera's range for remote monitoring, viewing, or recording of a distant or obscured person, object, or area. A continuous video stream may be multimedia captured by a video camera that may be processed to extract event data. The multimedia may be video, audio, or sensor data collected by sensors. In addition, the multimedia may include any combination of video, audio, and sensor data. The continuous video data stream may be constantly generated to capture event data about the environment being monitored.

Various lenses, filters, and other optical devices, such as zoom lenses, wide angle lenses, mirrors, prisms, and the like may also be used with the image capture device to assist in capturing the desired view. The image capture devices may be stationary, i.e., fixed in a particular orientation and configuration. The image capture device (along with any of its accompanying optical devices) may also be fixed on a gimbal and be programmable in orientation and position. It can also be capable of moving along one or more directions, such as up, down, left, and right; and/or rotate about one or more axes of rotation. The image capture device may also be capable of moving to follow or track an object, including a person, an animal, or another object in motion. In other words, the image capture device may be capable of moving about an axis of rotation in order to keep a person or object within a viewing range of the device's lens.

The image capture device may also be programmable for light sensitivity level, focus, and other parameters. Programming data may be provided via a computing device.

Computer code for performing the steps of the methods described in this document may be stored in a computer program product. The computer program product may include one or more storage media, for example, magnetic storage media such as magnetic disk or magnetic tape; optical storage media such as optical disk, optical tape, or machine readable bar code; solid-state electronic storage devices such as random access memory (RAM), or read-only memory (ROM); or any other physical device or media employed to store a computer program having instructions for practicing a method according to the embodiments described in this document.

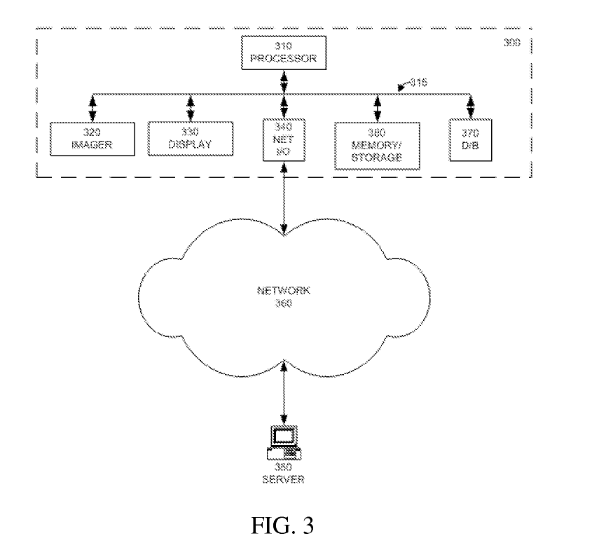

FIG. 3 is a simplified block diagram representation of an exemplary computer-based system 300 configured in accordance with selected aspects of the embodiments described in this document. The system 300 may be configured to perform all or selected steps of the processes 100 and 200 described above. The system 300 may be an intelligent store display. It may be built, for example, on a personal computer platform such as a Wintel PC or a Mac computer, a special purpose data processor, or a group of networked computers or computer systems an intelligent store display. The personal computer may be a desktop or a notebook computer.

As shown in FIG. 3, the system 300 includes a processing device 310. The processing device 310 is coupled to an imager (camera) 320, and a programmable display 330. The system 300 may also include a network interface 340 for communicating with a remote server 350; the communications between the system 300 and the remote server 350 may flow through one or more networks 360, which may include one or more wide area networks such as the Internet. The processing device 310 is also coupled to a local database 370 and various memories and/or storage devices 380. A bus 315 may be used to couple the individual components of the system 300.

As noted above, some of the process steps may be performed by the system 300, by the server 350, or by both the system 300 and the server 350.

FIG. 3 does not show many hardware and software modules of some variants of the system 300 and the server 350, and may omit several physical and logical connections.

The processing device 310 is configured to read and execute program code instructions stored in a machine readable storage device. Under control of the program code, the processor 310 configures the system 300 to perform the steps of the methods described throughout this document. The program code instructions may be embodied in other machine-readable storage media, such as additional hard drives, CD-ROMs, DVDs, Flash memories, and similar devices. The program code can also be transmitted over a transmission medium, for example, over electrical wiring or cabling, through optical fiber, wirelessly, or by any other form of physical transmission. The transmission can take place over a dedicated link between telecommunication devices, or through a wide- or local-area network, such as the Internet, an intranet, extranet, or any other kind of public or private network. In one embodiment, the program code is downloaded to the system 300 through the network interface 340.

In operation of the intelligent store display, the camera 320 captures (e.g., the step 105) images of persons in a store, for example, in a particular location of the store. The processing device 310 analyzes the images (e.g., the steps 110 through 120) to select appropriate advertisement(s) (stimulus or stimuli) for rendering to the persons. The processing device 310 then causes the programmable display 330 to display the selected advertisement(s) (the step 125). The processing device 310 may also be coupled to a sales terminal to sense (the step 130) the person's behavior or the outcome responsive to the displayed advertisement(s). Based on the sensed behavior or outcome, the processing device 310 updates its own database and/or transmits (the step 135) the learned information to the server.

This document describes in considerable detail the inventive apparatus, methods, and articles of manufacture for capturing and analyzing low level features and selecting stimuli based on the analysis of the low level features. This was done for illustration purposes only. Neither the specific embodiments of the invention as a whole, nor those of its features necessarily limit the general principles underlying the invention. The specific features described herein may be used in some embodiments, but not in others, without departure from the spirit and scope of the invention as set forth herein. Various physical arrangements of components and various step sequences also fall within the intended scope of the invention. Many additional modifications are intended in the foregoing disclosure, and it will be appreciated by those of ordinary skill in the pertinent art that in some instances some features will be employed in the absence of a corresponding use of other features. The illustrative examples therefore do not necessarily define the metes and bounds of the invention and the legal protection afforded the invention, which function is carried out by the claims and their equivalents.

What is claimed is:

1. A computer-implemented method comprising steps of:
obtaining at least one image of a person, the at least one image comprising at least part of a face of the person;
extracting low level features from the at least one image, thereby obtaining extracted low level features;
examining the extracted low level features to designate one or more designated stimuli likely to result in one or more preferred behaviors associated with the person; and
rendering at least one stimulus from among the one or more designated stimuli.

2. A computer-implemented method according to claim 1,
wherein the one or more designated stimuli comprise a plurality of designated stimuli;
the method further comprises analyzing the plurality of designated stimuli based on one or more predetermined criteria to select the at least one selected stimulus; and
the step of rendering comprises rendering the at least one selected stimulus.

3. A computer-implemented method according to claim 2, wherein the step of extracting comprises applying a plurality of Gabor filters to an output of a pixel mask of the at least one image.

4. A computer-implemented method according to claim 2, wherein the step of extracting comprises applying a plurality of Box Filters to an output of a pixel mask of the at least one image.

5. A computer-implemented method according to claim 2, wherein the step of extracting comprises applying a sequence of Haar Wavelets to the at least one image.

6. A computer-implemented method according to claim 2, wherein the step of extracting comprises applying a scale-invariant feature transform to the at least one image.

7. A computer-implemented method according to claim 2, wherein the step of extracting comprises at least one of:
applying a plurality of filters to an output of a pixel mask of the at least one image;
applying a sequence of Haar Wavelets to the at least one image; and
applying a scale-invariant feature transform to the at least one image.

8. A computer-implemented method according to claim 7, wherein the step of examining comprises comparing the extracted low level features to reference features in one or more databases with associations of the reference features and behaviors, so that the one or more designated stimuli are likely to result in one or more preferred behaviors.

9. A computer-implemented method according to claim 8, wherein the step of analyzing comprises evaluating the plurality of designated stimuli based on one or more economic criteria to select a single stimulus with highest expected economic return from among the plurality of designated stimuli.

10. A computer-implemented method according to claim 8, wherein the step of analyzing comprises evaluating the plurality of designated stimuli based on one or more economic criteria to select at least two stimuli so that expected economic return is highest possible for any subset of two or more stimuli from among all the designated stimuli.

11. A computer-implemented method according to claim 8, wherein the step of analyzing comprises evaluating the plurality of designated stimuli based on one or more economic criteria to select the at least one selected stimulus.

12. A computer-implemented method according to claim 11, wherein the at least one selected stimulus comprises an image.

13. A computer-implemented method according to claim 11, wherein the at least one selected stimulus comprises a sound.

14. A computer-implemented method according to claim 11, wherein the at least one selected stimulus comprises a smell.

15. A computer-implemented method according to claim 11, wherein the at least one selected stimulus comprises presentation of a product.

16. A computer-implemented method according to claim 11, further comprising storing a reaction of the person to the at least one selected stimulus.

17. A computer-implemented method according to claim 11, further comprising storing an outcome caused by the at least one selected stimulus.

18. A computer-implemented method according to claim 18, wherein the outcome comprises data describing occurrence or non-occurrence of a transaction with the person or with another person associated with the person.

19. A computer based system comprising a processor, a memory storing machine readable instructions, a display, and a camera, the system being configured to
obtain through the camera at least one image of a person, the at least one image comprising at least part of a face of the person;
extract low level features from the at least one image, thereby obtaining extracted low level features;
examine the extracted low level features to designate one or more designated stimuli likely to result in one or more preferred behaviors associated with the person; and
render on the display at least one stimulus from among the one or more designated stimuli.

20. A computer based system according to claim 19, wherein
the one or more designated stimuli comprise a plurality of designated stimuli; and
the system is further configured to analyze the plurality of designated stimuli based on one or more predetermined criteria to select the at least one stimulus from among the plurality of designated stimuli.

21. An article of manufacture comprising one or more memory devices storing computer code, wherein the code, when executed by at least one computer based system, configures the at least one computer based system to perform a method comprising:
obtaining at least one image of a person, the at least one image comprising at least part of a face of the person;
extracting low level features from the at least one image, thereby obtaining extracted low level features;
examining the extracted low level features to designate one or more designated stimuli likely to result in one or more preferred behaviors associated with the person; and
rendering at least one stimulus from among the one or more designated stimuli.

22. An article of manufacture according to claim 21, wherein:
the one or more designated stimuli of the method comprise a plurality of designated stimuli;
the method further comprises analyzing the plurality of designated stimuli based on one or more predetermined criteria to select the at least one selected stimulus; and
the step of rendering comprises rendering the at least one selected stimulus.
